(19) United States
(12) Patent Application Publication
(10) Pub. No.: US 2006/0112296 A1
(43) Pub. Date: May 25, 2006

(54) Data recovery system for appliances

(76) Inventors: Thomas J. Sheahan, Cary, IL (US); Keith M. Kolmos, Elgin, IL (US); Raymond E. Altenburger JR., Bartlett, IL (US)

Correspondence Address: HARNESS, DICKEY & PIERCE, P.L.C., P.O. BOX 828, BLOOMFIELD HILLS, MI, 48303, US

(21) Appl. No.: 10/983,237

(22) Filed: Nov. 5, 2004

(51) Int. Cl. G06F 11/00

(52) U.S. Cl. 714/2

(57) ABSTRACT

An improved data recovery system for appliances is provided. The system includes an operating module with operating memory which controls the appliance, a recovery module which recovers operation of the device upon a power disturbance, and a data storage device. During operation, critical data is saved to the data storage device. In the event of a power disturbance causing the operating module to reset, the data storage device is checked for valid saved critical data which, if found, is loaded into the computing device's operating memory upon power restoration. In this way, the system is able to recover operation from the point at which critical data was last saved, without the use of a power loss detection circuit and large capacitor used in traditional systems to detect power loss, and power the system while critical data is saved.

### FIELD OF THE INVENTION

The present invention relates to a data recovery system for appliances, and more particularly to a data recovery system used for the control of appliances which recovers critical data relating to the operation of the appliance and enables continued operation of the appliance after a power disturbance.

### BACKGROUND OF THE INVENTION

Appliances are often controlled by an electronic control system, such as an embedded system, controller, microcontroller, computing device, or other similar device, that generally consists of a combination of hardware and software designed to control the operation of the appliance. The control system is subject to interruptions due to power disturbances. Power disturbances include disturbances to the power supply of the control system such as power outages, power interruptions, fluctuations in voltage, and fluctuations in current. Power disturbances also include fluctuations in voltage and current on the input and output lines connected to the control system. If not sufficiently protected, a power disturbance can result in the loss of data and an interruption in the operation of the appliance.

Historically, control systems have been equipped with additional hardware which, in the event of a power disturbance, allows the control system to save critical data before terminating operation. The additional hardware typically includes a large capacitor sufficient to provide power long enough to save the critical data in non-volatile memory. The additional hardware also typically includes a power disturbance detection circuit which sends a signal to the control system to alert the control system of a power disturbance.

Upon receiving such a signal, the control system, operating on power from the large capacitor, saves critical data. The additional hardware results in additional expense and utilizes additional space.

Therefore, it is desirable to provide a control system that is able to recover critical data subsequent to a power disturbance, without the use of such additional hardware, at a lower cost and resulting in a smaller control system.

### SUMMARY OF THE INVENTION

In accordance with the present invention, an improved control system for control of appliances is provided which is able to recover critical data in the event of a power disturbance. The system includes: an operating module, for controlling the operation of the appliance, an operating memory accessible by the operating module, a recovery module, and a data storage device.

During normal operation, the operating module performs normal appliance operations, while periodically saving critical data from the operating memory to the data storage device. In the event of a power disturbance, the operating module is reset. Upon reset, the recovery module checks the data storage device for valid critical data. If valid critical data is available, the recovery module loads the critical data into the operating memory, and operation of the appliance is recovered from the point at which the critical data was last saved. If critical data is not available, the recovery module initializes without recovery. Normal operating functions are then performed by the operating module, with critical data being saved periodically to the data storage device.

In this way, the control system is able to recover operation based on the saved critical data, without the use of the additional hardware traditionally needed to allow the control system to save critical data in the event of a power disturbance.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a block diagram showing the elements of the control system in accordance with the invention.

FIG. 2 is a flow chart illustrating the flow of control of the control system in accordance with the invention.

FIG. 3 is a flow chart illustrating the flow of control for checking the data storage device for valid saved critical data in accordance with the invention.

FIG. 4 is a flow chart illustrating the flow of control for performing normal operating functions in accordance with the invention.

FIG. 5 is a diagram of an exemplary system residing in an oven.

### DETAILED DESCRIPTION OF THE PREFERRED EMBODIMENTS

The following description of the preferred embodiments is merely exemplary in nature and is in no way intended to limit the invention, its application, or uses. Reference is made to an exemplary system which resides in an oven. However, it is understood that the invention can be used for any appliance, and that the drawings and depictions are examples only.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

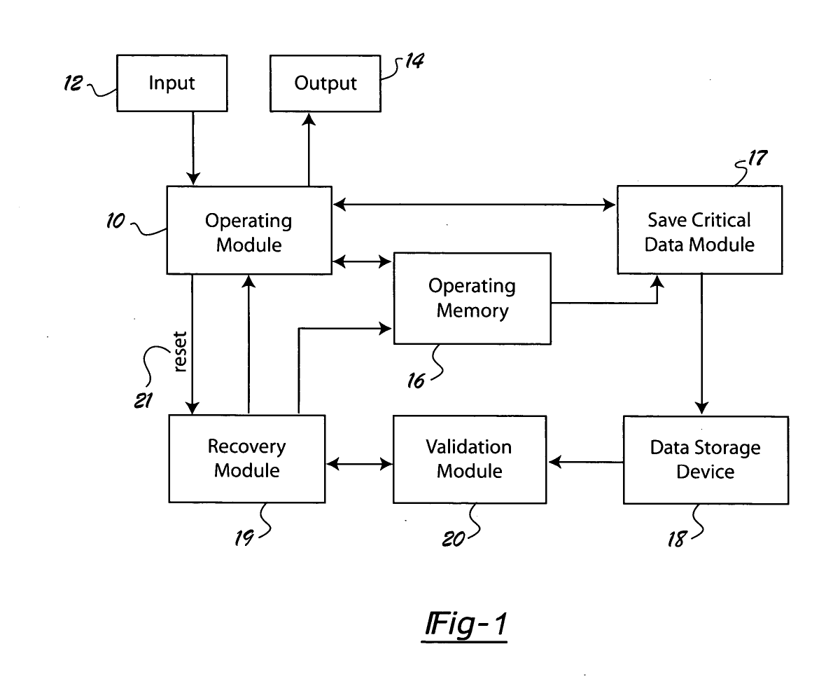

FIG. 1 is block diagram, which depicts the elements for a control system in accordance with the invention. The operating module 10 controls normal operation of the appliance. The operating module 10 receives input 12. The input 12 may consist of input from the user, such as an operation the user would like the appliance to perform. The input 12 may also consist of data from the appliance itself.

The operating module 10 delivers output 14. The output 14 may consist of status information about the appliance to be displayed to the user. The output 14 may also include outputs 14 necessary to control the parts and operations of the appliance. For example, the output 14 may include signals to the mechanical elements of the appliance used to carry out appliance operations.

The operating module 10 accesses and utilizes operating memory 16 to operate. The operating module uses the operating memory 16 to store data and to perform operations on the data as necessary to operate the appliance. The operating memory 16 will typically consist of random access memory (RAM), but may consist of other types of memory or data storage devices as well.

The operating module 10 communicates with a save critical data module 17. During operation of the appliance, the operating module 10 periodically commands the save critical data module 17 to save critical data.

The critical data is the data necessary for the operation of the appliance. Specifically, the critical data will consist of the data necessary to allow the control system to continue operation from the point at which the critical data was most recently saved. For example, the critical data may consist of the current operation being performed by the appliance, and any data necessary for that operation, such as the time left on that operation, and any of the data values necessary for the operation. In this way, the critical data necessary for operation of the appliance will be available on the data storage device 18 for recovery if the operating module 10 is reset due to a power disturbance.

The save critical data module 17 retrieves critical data from the operating memory 16 and saves the critical data to the data storage device 18. Once the save critical data module 17 has saved the critical data, it notifies the operating module 10 to continue operation. Alternatively, the operating module 10 may simply wait for a sufficient period of time for the save critical data module 17 to save the critical data before continuing operation. In such case, it would not be necessary for the save critical data module 17 to notify the operating module 10 that it had finished saving critical data.

Critical data may be saved at a number of points during operation of the operating module 10. The operating module 10 may command the save critical data module 17 to save critical data upon the occurrence of an event. For example, the operating module 10 may command the save critical data module 17 to save critical data at the end of an iteration of normal appliance functions, or at different points during an iteration of normal appliance functions. Additionally, the operating module 10 may command the save critical data module 17 to save critical data based upon a predetermined period.

The data storage device 18 may be non-volatile memory, such as electrically erasable programmable read only memory (EEPROM), erasable programmable read only memory (EPROM), flash memory, magnetic media, optical media, or other non-volatile memory suitable for storing data. The data storage device 18 may also be volatile memory such as RAM.

If non-volatile memory is used as the data storage device 18, the control system will be able to recover from sustained power disturbances of indefinite length. If volatile memory, such as RAM, is used, the control system is able to recover from brief power disturbances. In particular, RAM can typically retain its memory contents for about 5 to about 10 seconds subsequent to a power disturbance before its data is lost. In a RAM implementation, then, the control system is able to recover the saved critical data provided that power is restored or normalized within about 5 to about 10 seconds.

In an implementation of the invention that utilizes the same type of data storage device for both the operating memory 16 and the data storage device 18, the operating memory 16 and the data storage device 18 may be combined in the same physical data storage device. For example, a single RAM device could be used as both the operating memory 16 and the data storage device 18. In such a case, the memory locations on the device would be allocated so that some of the memory locations serve as the operating memory 16 and some of the memory locations serve as the data storage device 18.

After the critical data is saved by the save critical data module 17, the operating module 10 performs normal operating functions while periodically instructing the save critical data module 17 to save critical data. The operating module 10 continues to function normally until a power disturbance causes it to be interrupted. When power is restored or normalized after a power disturbance, the operating module 10 enters a reset state.

When the operating module 10 is in the reset state, the recovery module 19 commences recovery operations, and communicates with the validation module 20. The recovery module 19 receives notification that the operating module 10 has been reset 21.

The recovery module 19 commences by initializing necessary devices or hardware. The recovery module 19 then directs the validation module 20 to check for saved critical data.

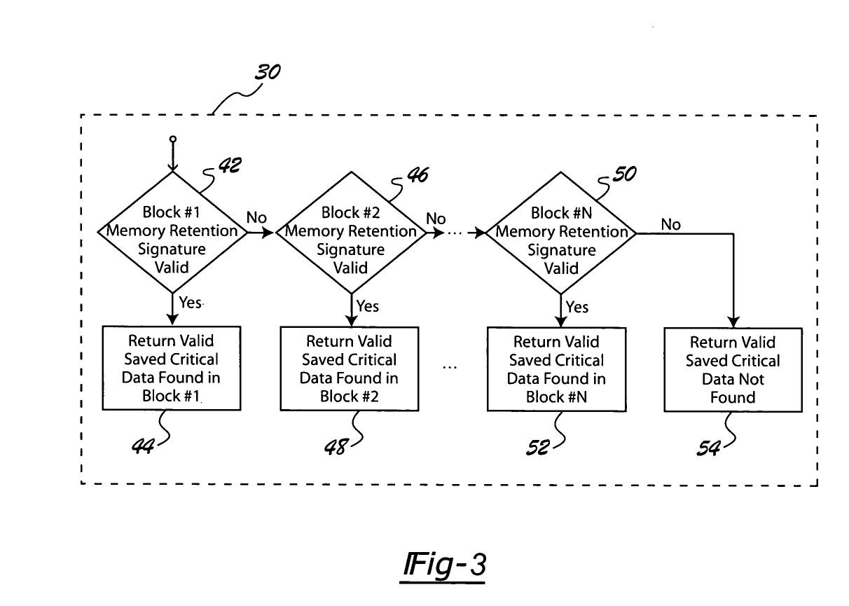

The validation module 20 checks the data storage device 18 for valid saved critical data. The way in which the data storage device 18 is checked for valid saved critical data is set forth more fully in FIG. 3, and described in more detail below. The validation module 20 uses an error checking method and a memory retention signature to verify the integrity of the data contained on the data storage device 18.

If valid saved critical data is located on the data storage device 18, the valid saved critical data is returned to the recovery module 19 by the validation module 20. If valid saved critical data is not located, then the validation module notifies the recovery module that no valid saved critical data was found.

The recovery module 19 then loads the operating memory 16 appropriately. If valid saved critical data was located by the validation module 20, the recovery module 19 loads the valid saved critical data into the operating memory 16. If valid saved critical data was not located, the recovery module 19 initializes the operating memory.

Once the recovery module 19 has loaded the operating memory 16, the recovery module 19 notifies the operating module 10 to commence normal operation of the appliance.

In this way, if valid critical data was located, operation will resume from the point at which the valid critical data was saved. By recovering saved critical data, the control system is able to continue operation after a power disturbance. The recovery is performed without the use of additional hardware traditionally required for power disturbance recovery, such as a power disturbance detection circuit and large capacitor. The resulting control system thereby requires less hardware and is smaller than the traditional appliance control system.

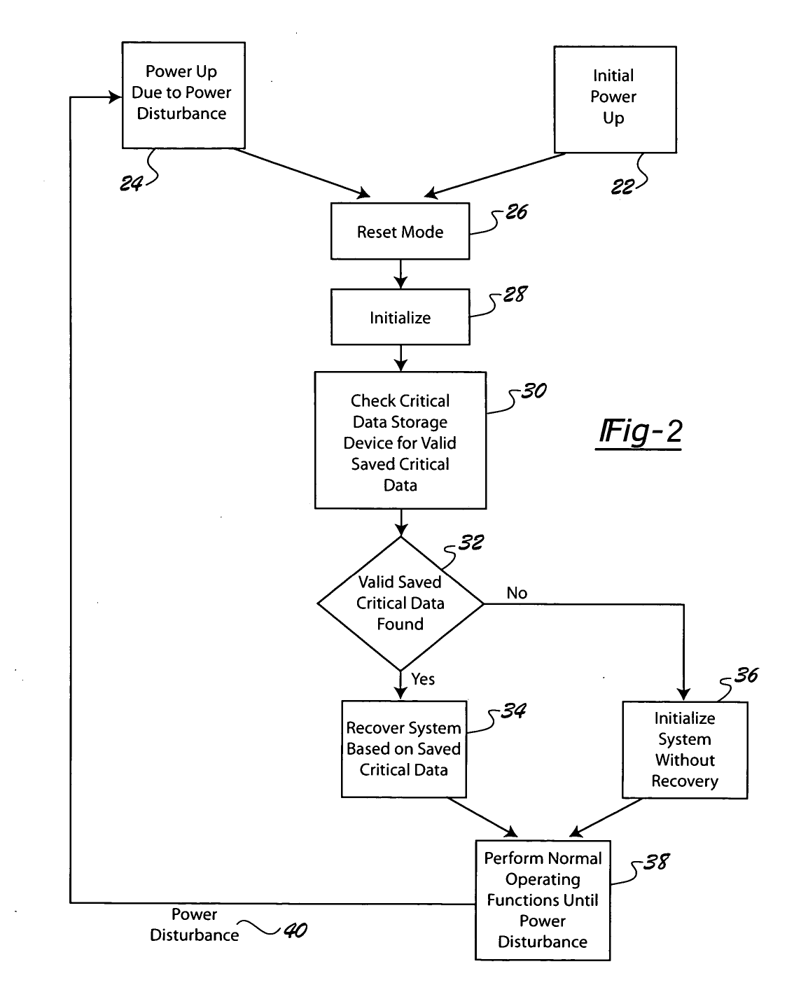

FIG. 2 is a flow chart depicting the flow of control of the control system. The control system is powered up. The power up may be an initial power up 22, such as when the appliance is first plugged in and turned on by the user. The power up may also be due to a power disturbance 24. A power disturbance may consist of a loss of power or a fluctuation in power sufficient to restart the control system.

After power up 22, 24, the control system initializes into a reset state 26.

After reset 26, necessary hardware devices are initialized 28.

The data storage device 18 is then checked for valid saved critical data 30. The way in which the data storage device 18 is checked for valid saved critical data is set forth more fully in FIG. 3, and described in more detail below.

The control system then determines whether valid saved critical data was found 32 on the data storage device 18.

If valid saved critical data is found 32 on the data storage device 18, then recovery is based on that saved critical data 34. To recover the control system based on saved critical data 34, the saved critical data is loaded into the operating memory 16. In this way, operation of the appliance continues from the point at which critical data was last saved prior to entering the reset state.

If valid saved critical data is not found, the control system is initialized without recovery 36.

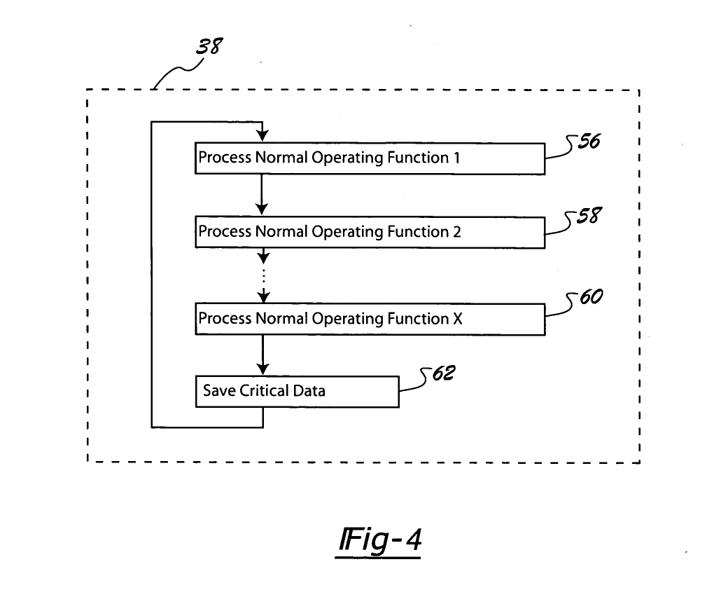

Normal operating functions are then performed 38. The normal operating functions are set forth more fully in FIG. 4, and described in more detail below.

Normal operations 38 are continued until there is a power disturbance 40. Subsequent to power being restored or normalized after the power disturbance 40, the control system powers up 24. The power up, at this point, is due to power disturbance 24, as opposed to an initial power up 22.

FIG. 3 is a flow chart depicting the flow of control with regard to checking the data storage device 18 for valid saved critical data 30. It is understood that the functionality of the FIG. 3 flow chart is a description of the operation encapsulated in the “check critical data storage device for valid saved critical data” 30 box of FIG. 2.

In FIG. 3, the data storage device 18 is checked for saved critical data. An error check method utilizes a memory retention signature, saved with the critical data, to verify the integrity of the data. The memory retention signature of the first memory block location is checked 42. If the memory retention signature is valid, the valid saved critical data found in the first memory block is returned 44. If the memory retention signature is not valid, then the second memory block location is checked 46, and so on, until the Nth memory retention signature is checked 50 (where N is the number of memory locations in the data storage device 20 allocated for the saving of critical data). In this way, the memory block locations are checked consecutively until valid critical data is found.

Once valid critical data is found, the valid saved critical data is returned 44, 48, 52, and recovery commences based on the saved critical data 34. If valid saved critical data is not found, then critical data is not returned 54, and the control system is initialized without recovery 36.

FIG. 4 is a flow chart depicting the flow of control with regard to performing the normal operating functions 38. It is understood that the functionality of the FIG. 4 flow chart is a description of the operation encapsulated in the “perform normal operating functions until power disturbance” 38 box of FIG. 2.

In FIG. 4, the normal operating functions 56, 58, 60 are performed in sequence. The first operating function is performed 56, followed by the second 58, and so on, until operating function X is performed 60, where X is the number of operating functions for the particular operation being performed.

The normal operating functions 40 may consist of checking the input 12, performing any appropriate operations and calculations, and updating the output 14. For example, the normal operating functions 40 of the appliance may include checking the user input for a new instruction, checking appliance input, adjusting the output to the user and adjusting the appliance output to carry out the current appliance operation as necessary.

After completing the last sequential normal operating function X 60, one iteration of normal operating functions will have been completed. Traditionally, the control system would now simply commence another cycle of normal operating functions by returning to the first such operating function 56.

The invention, however, saves critical data 62 before commencing with another cycle of normal operating functions. The invention finishes an iteration of normal operating functions, and then saves critical data 62 to the data storage device 18. While the embodiment described herein saves critical data once at the end of an iteration of normal operating functions, it is understood that critical data could also be saved multiple times during an iteration of normal operating functions for added reliability of saved critical data. In addition, critical data could be saved based upon the passage of a time interval, rather than at certain points during an iteration of operating functions.

In this way, critical data will be available on the data storage device 18 and will be used to recover operation of the appliance in the event of a power disturbance. The appliance will continue operating from the point at which the critical data was saved.

Because the critical data is saved during normal operating functions 40, the additional hardware required with a traditional system, such as a power loss detection circuit and large capacitor, is no longer necessary.

There are a number of ways in which critical data may be checked 30 and saved 62. While specific configurations are mentioned herein, this system may be constructed with many different configurations as necessary or desired for a particular application. Thus, the description of the invention is merely exemplary in nature and variations that do not depart from the gist of the invention are intended to be within the scope of the invention.

For example, only one location on the data storage device 18 may be allocated for saving critical data. In such an implementation, the control system would be able to recover from all power disturbances, unless the power disturbance occurs while data is being saved to the data storage location.

As an additional example, two locations on the data storage device 18 may be allocated for saving critical data. In such case, critical data could be saved to both locations each time critical data is saved 62. In this way, if a power disturbance 40 occurred while critical data was being saved to one location, valid critical data would remain available in the other memory location.

Additionally, if more than two memory locations on the data storage device 18 are allocated for saving critical data, then the control system could save critical data to the memory device 18 starting with the first allocated location on the first iteration of normal operating functions, and continuing with the second memory block location on the second iteration, and so on. Once all of the allocated locations on the data storage device 18 have been used, the control system would start over at the first location.

In such a case, multiple locations on the data storage device 18 would likely contain valid critical data at the time of a power disturbance. To ensure that the most recently saved critical data is used on recovery, an increasing sequence number could be saved with the critical data. When the data storage device 18 is checked for critical data 30, instead of terminating the search after locating the first valid data, the computing device would check all memory locations for valid critical data, and use the valid critical data with the highest sequence number. In this way, the most recently saved critical data would be used on recovery.

If EEPROM is used as the data storage device 18, then more than two data recovery memory block locations may be employed to advantageously extend the life of EEPROM. It is known that the number of write operations an EEPROM will sustain is finite. This is typically referred to as the maximum specified write operations for the EEPROM. Using a larger number of memory block locations on the EEPROM will decrease the number of times each memory location is written to, thereby extending the life of the EEPROM. In addition, more than one EEPROM could be used.

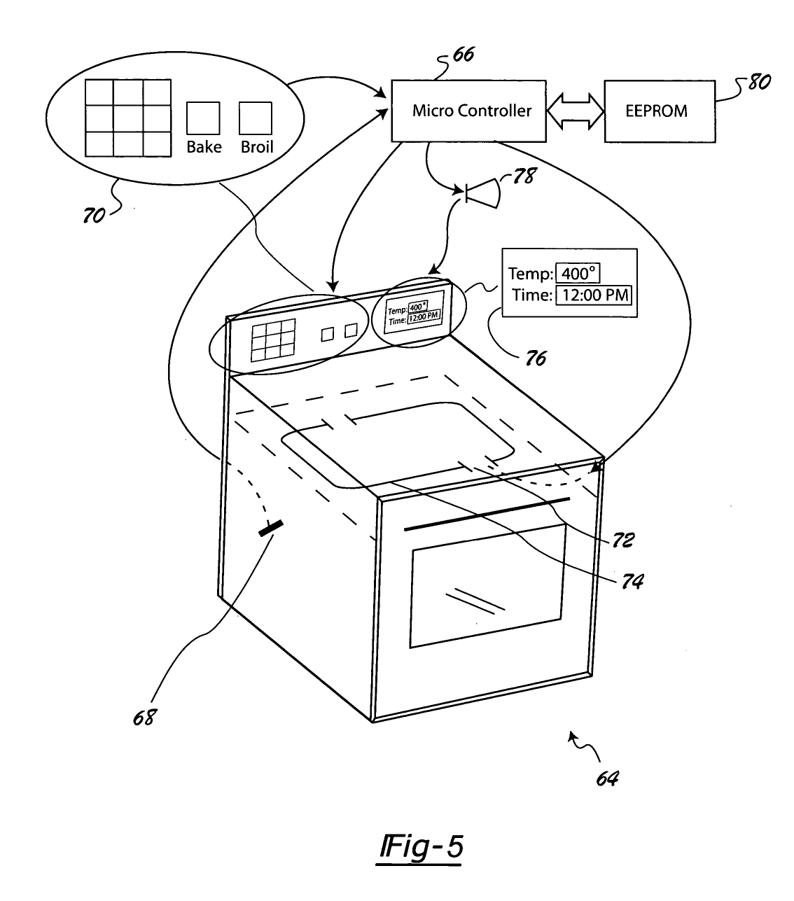

FIG. 5 is a diagram of an exemplary system in accordance with the invention which resides in an oven 64. While FIG. 5 is a specific implementation of the invention in an oven 64, it is understood that the invention can be used for any appliance or consumer electronic device, and that the drawings and depictions are examples only. Further, the identification of specific elements in this implementation is exemplary only.

In the oven 64, the control system is implemented with a microcontroller 66. It is understood that the microcontroller 66 includes internal operating RAM (not pictured) as the operating memory 16, and that the microcontroller is programmed with software to operate in the manner described herein.

The data input for the microcontroller 66 consists of input from a temperature sensor 68, and input from user keys 70. The temperature sensor 68 provides a signal indicative of oven temperature to the microcontroller 66. The user keys 70 provide user input to the microcontroller 66.

The user selects operations, such as bake or broil, along with data indicating the length of time for such operation via the user keys 70. The microcontroller 66 sends output to oven relays 72 which control the heating coils 74. The microcontroller 66 also sends output to a user display 76, which displays the current status of the oven 64, such as temperature and time left for the operation. The microcontroller 66 also sends output to an audible beeper 78, to signal the end of an operation.

The memory device in the oven 64 is EEPROM 80. The critical data set for the oven 64 would include such items as the current operation of the oven 64, the operating temperature set point, and time remaining on the current operation.

Reference will now be made to the flow of control FIG. 2 in the specific example of the oven 64. The oven 64 is initially plugged in by the user and the microcontroller 66 is powered up 22. The microcontroller 66, which has been factory pre-programmed, enters reset 26 and undergoes initialization 28. The microcontroller 66 checks the EEPROM 80 for valid saved critical data 30. Finding none, the microcontroller 66 initializes the system without recovery 36.

The microcontroller 66 now commences its normal operating functions 38. Initially, the normal operating functions consist of waiting for input from the user. The user selects an operation via the user keys 70. The user, for example, may select a bake operation at 400 degrees for 12 minutes. The microcontroller 66 stores the temperature set point of 400 degrees, the current operation of bake, and the time remaining of 12 minutes in its operating memory 16, which is the microcontroller's internal RAM.

The microcontroller 66 adjusts its output to carry out the user operation. The microcontroller 66 turns on the heating coils 74 via the relays 72. The microcontroller 66 displays the time remaining and current temperature on the user display 76. Having come to the end of a cycle of normal operating functions 38, the microcontroller 66 saves the critical data 62, including the current set temperature of 400 degrees, the operation of bake, and the time remaining, in the EEPROM 80. The microcontroller 66 then repeats the cycle of normal operating functions 38 by checking for new user input from the user keys 70, checking the temperature sensor 68, and adjusting the relays 72 and user display 76 as necessary.

At the end of an iteration of operating functions 38, the microcontroller saves the critical data to the EEPROM 80. Upon successive iterations, the remaining time of the operation will decrease in increments.

The microcontroller 66 continues in this fashion until the user operation is terminated, or until the microcontroller 66 is reset by a power disturbance 40.

If the microcontroller 66 is reset by a power disturbance 40, the microcontroller 66, upon power being restored or normalized, will power up 24, enter reset mode 26, and initialize 28.

The microcontroller 66 will then check the EEPROM 80 for valid saved critical data 32. If the EEPROM 80 contains valid saved critical data it will be used to recover the system 34. The microcontroller 66 loads the saved critical data into its operating memory, and continues the user operation from the point at which critical data was last saved. For example, if the power disturbance occurred in the middle of the user's bake operation, the bake operation critical data would be loaded, and the appliance would continue the bake operation from the point at which critical data was last saved.

For power disturbances of short duration, the user may not even be aware that the power disturbance occurred.

While the exemplary embodiment of the data recovery system for appliances has been described above with specific types of memory arranged in a specific configuration, this system may be constructed with many different configurations, and memory components as necessary or desired for a particular application. The above configurations and components are presented only to describe one particular embodiment and should be viewed as illustrating, rather than limiting, the present invention. Thus, the description of the invention is merely exemplary in nature and variations that do not depart from the gist of the invention are intended to be within the scope of the invention. Such variations are not to be regarded as a departure from the spirit and scope of the invention.

What is claimed is:

1. A data recovery system for appliances comprising:
an operating module that controls the operation of the appliance and manages critical data necessary for the operation of the appliance;
operating memory accessible by the operating module;
a data storage device;
a save critical data module that saves the critical data to the data storage device;
a validation module that retrieves critical data from the data storage device and determines the validity of the critical data; and
a recovery module that provides the critical data to the operating memory and notifies the operating module to control operation of the appliance;
wherein the recovery module enables operation of the validation module when the operating module is in a reset state.

2. The data recovery system of claim 1 wherein the validation module notifies the recovery module if the critical data is not valid.

3. The data recovery system of claim 2 wherein the recovery module directs the operating module to restart if the critical data is not valid.

4. The data recovery system of claim 1 wherein the validation module retrieves critical data from a first storage location of the data storage device, determines the validity of the critical data and, if the critical data retrieved from the first storage location of the data storage device is not valid, then retrieves critical data from a second storage location of the data storage device.

5. The data recovery system of claim 1 wherein the data storage device is selected from the group comprising nonvolatile memory and volatile memory.

6. The data recovery system of claim 1 wherein the data storage device is selected from the group comprising RAM, EEPROM, EPROM, flash memory, magnetic media, and optical media.

7. The data recovery system of claim 1 wherein the operating module notifies the save critical data module to save the critical data.

8. The data recovery system of claim 7 wherein the operating module notifies the save critical data module to save critical data at least once in a predetermined time interval.

9. The data recovery system of claim 7 wherein the operating module performs iterations of appliance operating functions.

10. The data recovery system of claim 9 wherein the operating module notifies the save critical data module to save critical data at least once during an iteration of appliance operating functions.

11. The data recovery system of claim 1 wherein the data storage device contains multiple storage locations allocated for critical data.

12. The data recovery system of claim 11 wherein the save critical data module saves critical data in at least one of the multiple storage locations of the data storage device.

13. The data recovery system of claim 12 wherein the validation module retrieves and determines the validity of critical data from one of the multiple storage locations of the data storage device, and if the critical data is not valid, then retrieves and determines the validity of critical data from other storage locations of the data storage device, until the validation module determines that a storage location contains critical data, or until the validation module has retrieved critical data from all of the multiple storage locations allocated for critical data.

14. The data recovery system of claim 12 wherein the operating module generates a sequence number which is periodically incremented by the operating module and wherein the sequence number is saved with the critical data by the save critical data module to the data storage device.

15. The data recovery system of claim 14 wherein the validation module retrieves, and determines the validity of, critical data from each of the multiple storage locations of the data storage device, compares the sequence numbers of the valid critical data from each of the multiple storage locations, and provides the critical data with the highest sequence number to the recovery module.

16. A data recovery system for appliances comprising:
an operating module that controls the operation of the appliance and manages critical data necessary for the operation of the appliance;
a memory device with an operating memory section that is accessible by the operating module and a data storage section;
a save critical data module that saves the critical data to the data storage section of the memory device;
a validation module that retrieves critical data from the data storage section of the memory device and determines the validity of the critical data; and
a recovery module that provides the critical data to the operating memory section of the memory device and notifies the operating module to control operation of the appliance;
wherein the recovery module enables operation of the validation module when the operating module is in a reset state.

17. A method for recovering data in an appliance comprising:
operating an appliance with an operating module;
managing and accessing critical data necessary for the operation of the appliance in an operating memory;
saving the critical data to a data storage device during the operation of the appliance;
resetting the operating module to a reset state upon a power disturbance;
recovering saved critical data from the data storage device, when the operating module is in a reset state;
providing the critical data from the data storage device to the operating memory;
and notifying the operating module to continue operating the appliance;

18. The method of claim 17 wherein said recovering saved critical data from the data storage device comprises retrieving critical data from a first storage location of the data storage device, determining the validity of the critical data and, if the critical data retrieved from the first storage location of the data storage device is not valid, then retrieving critical data from a second storage location of the data storage device.

19. The method of claim 17 wherein said recovering saved critical data from the data storage device comprises:
retrieving critical data from a data storage location of the data storage device;
determining the validity of the critical data from the storage location of the data storage device;
if the critical data retrieved from the storage location is not valid, then retrieving critical data from an n^{th} data storage location of the data storage device, where n is greater than 1;
determining the validity of the critical data from the n^{th} storage location of the data storage device; and
repeating until critical data retrieved from the data storage device is determined to be valid or until critical data has been retrieved from all of the memory locations of the data storage device which contain critical data.

20. The method of claim 17 wherein said operating an appliance with an operating module comprises performing iterations of appliance operating functions, and wherein said saving the critical data to a data storage device during the operation of the appliance comprises saving the critical data at least once during an iteration of appliance operating functions.

21. The method of claim 17 wherein said saving the critical data to a data storage device during the operation of the appliance comprises saving the critical data at least once in a predetermined time interval.

22. The method of claim 17 wherein said operating an appliance with an operating module comprises generating a sequence number which is incremented at least once during a predetermined time interval, and wherein said saving the critical data to a data storage device during the operation of the appliance comprises saving the sequence number with the critical data to at least one storage location of the data storage device allocated for critical data.

23. The method of claim 22 wherein said recovering saved critical data from the data storage device comprises:
retrieving critical data from each storage location of the data storage device allocated for critical data; and
determining the validity of the critical data from each storage location of the data storage device allocated for critical data;
wherein said providing the critical data from the storage device to the operating memory comprises providing the critical data with the highest sequence number to the operating memory.
